(19) United States
(12) Patent Application Publication
(10) Pub. No.: US 2011/0255817 A1
(43) Pub. Date: Oct. 20, 2011

(54) Roller Bearing Cage

(76) Inventors: Berthold Beyfuss, Kaisten (DE); Hans-Jürgen Friedrich, Konigsberg (DE); Fred Fuchs, Schweinfurt (DE); Alfred Radina, Massbach (DE); Jonas Schierling, Hassfurt (DE)

(21) Appl. No.: 13/126,404

(22) PCT Filed: Oct. 21, 2009
(86) PCT No.: PCT/EP09/07541

§ 371 Date: Jul. 1, 2011

(30) Foreign Application Priority Data
Oct. 27, 2008 (DE) 10 2008 053 313.0

(51) Int. Cl. F16C 33/66; F16C 33/38; F16C 33/46

(52) U.S. Cl. 384/470

(57) ABSTRACT

A roller bearing cage includes at least one bridge element having a surface provided for directly opposing an outer surface of a roller body. A plurality of ship-hull-shaped or droplet-t-shaped macroscopic recesses is formed in the surface for retaining a lubricant therein. The recesses have at least one of a width and a depth in the circumferential direction of the roller body that diminishes towards at least one end in the circumferential direction. A first group of the recess diminishes in a direction substantially towards one of the ends and a second group of the recess diminishes in a direction towards the other end.

The invention concerns a roller bearing cage.

An array of measures are known in the prior art in order to ensure a sufficient supply of lubricant in lubricated roller bearings having cages in the roller contact areas as well as in the slide contact areas of the roller bearing, for a lifetime lubrication as well.

It is an object of the present invention to provide a roller bearing cage that is improved in particular with respect to the supply of lubricant.

The object is achieved by the subject matter of claim 1. Advantageous embodiments are described in the dependent claims.

According to claim 1, a roller bearing cage includes the following features:
At least one bridge element having a surface provided for directly opposing an outer surface of a roller,
the surface is formed with a plurality of ship-hull-like macroscopic recesses for retention of a lubricant,
the recesses are formed with diminishing width and/or depth in the circumferential direction of the roller towards at least one end in the circumferential direction, and
a plurality of recesses are disposed on the surface, of which a first group diminishes substantially towards one of the ends and the second towards the other end.

The invention is based upon the recognition that a sufficient supply of lubricant for the roller bearing is facilitated with the inventive construction of the bridge element, for a lifetime lubrication as well.

By forming the recesses so as to diminish in width and/or depth in the rotational direction of the roller, lubricant retained in the recesses is supplied in the rotational direction of the roller out of the recesses during operation of the roller bearing due to the volume segments within the recess that continuously diminish, in a manner of speaking, in the rotational direction, and thereby favorably influence the lubricant film. So that this functions independent of the rotational direction of the roller bearing, recesses that differ with respect to their diminishing direction are provided, in particular, in an alternating manner in the longitudinal direction of the bridge element.

Further advantages, features and details of the invention are derivable from the exemplary embodiments of the invention described in the following with the assistance of the Figures.

FIG. 1 shows in perspective view a cylindrical roller bearing cage having two circumferential elements with indentations for bridge elements having recesses,

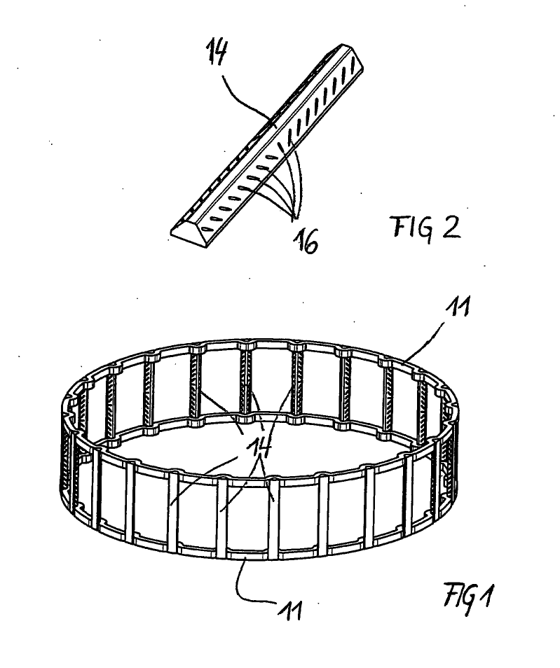

FIG. 2 shows in perspective view one of the bridge elements of FIG. 1,

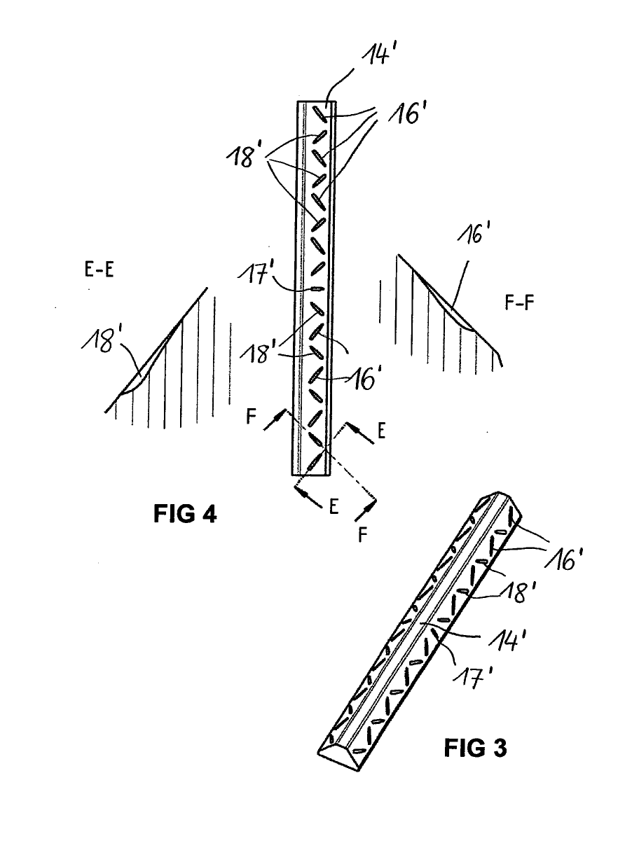

FIG. 3 shows in perspective view an alternative bridge element, and

FIG. 4 shows the bridge element of FIG. 3 in a top view towards one of the surfaces provided to directly oppose the outer surface of one of the cylindrical rollers of the cylindrical roller bearing, inclusive of two sections through two adjacent recesses denoted with E-E and F-F.

As an exemplary embodiment of the invention, FIG. 1 shows in perspective view a cylindrical roller bearing cage having two circumferential elements 11 having indentations for bridge elements 14 having a uniform trapezoid-shaped cross-section. The indentations 12 on the circumferential elements 11, together with the bridge elements 14 formed to correspond to the indentations 12, provide for a pre-positioning of the bridge elements 14 in the circumferential direction of the circumferential element 11 when the elements 11 and 14 are assembled for a welding of the bridge elements 14 on the circumferential elements 11.

The elements 11 and 14 are produced from an iron material, in particular from a steel wire. In other embodiments, however, other materials could be utilized and, instead of welding, soldering or adhesive could be applied. Furthermore, the bridge elements 14, in particular, can also be formed with a lamination in order to achieve a particular sliding behavior, in particular in the area of its contact surfaces with the roller bodies.

The bridge elements 14 are furnished on their surfaces, which are provided for directly opposing the roller outer surfaces, with recesses 16 for retention of a lubricant. The recesses 16 are formed ship-hull-like, but one can also say they are formed droplet-shaped.

FIG. 2 shows an enlarged perspective illustration of one of the bridge elements 14 having the recesses 16. In a left axial half of the bridge elements 14, the recesses 16 are formed obliquely and are disposed parallel to a line extending obliquely from the right cage portion to the cage middle point; in the right half they are formed in a corresponding mirrored-fashion and one recess 16 is radially oriented in the middle.

In another exemplary embodiment of the invention, FIG. 3 shows in perspective view a bridge element 14′ that represents an alternative to the bridge element 14 of FIGS. 1 and 2. FIG. 4 shows the bridge element 14′ of FIG. 3 in a top view towards one of the surfaces provided to directly oppose the outer surface of one of the cylindrical rollers of the cylindrical roller bearing, inclusive of two sections through two adjacent recesses 16′ and 18′ denoted with E-E and F-F.

Said surface of the bridge element comprises three different types of ship-hull-like recesses 16′, 17′ and 18′. All recesses 16′, 17′ are formed in a corresponding manner, such that they include a diminishing width and depth in the circumferential direction of the roller substantially up to one end in the circumferential direction. Referring to the middle drawing of FIG. 4, the recesses 16′ and 17′ diminish, in a manner of speaking, substantially towards the right side and the recesses 18′ towards the left side. The longitudinal extensions of the recesses 16′ and 18′ are oriented obliquely to the circumferential direction of the roller, wherein the recesses 16′ are tilted, however, in the opposite direction as compared to the recesses 18′ by a same acute angle with respect to said circumferential direction. The recesses 16′ are tilted on both sides of the recesses 17′ by the same angle, but in opposite directions, which also applies to the recesses 18′. Only the recess 17′ is oriented tangentially in the circumferential direction of the roller. The recess 16′ and 18′ are disposed in an alternating manner and are axially-symmetric with reference to the recess 17′.

Depending upon the cylindrical roller size, the depth of the recesses 16′, 17′ and 18′ ranges from less than a tenth of a millimeter up to a few millimeters, wherein the recesses 16′, 17′ and 18′ are formed to extend over a majority, in particular between 90% and 50%, of the extension of the surface in the roller circumferential direction.

1.-14. (canceled)

15. A roller bearing cage, comprising:
at least one bridge element having a support surface configured to directly oppose an outer surface of a roller body, and
a plurality of substantially ship-hull-shaped macroscopic recesses configured to retain lubricant therein, the recesses being formed in the support surface across between 50-90% of a circumferential direction of the support surface, each recess having at least one of a width and a depth that diminishes in the circumferential direction, a first group of the recesses diminishing substantially towards one circumferential end and a second group of the recesses diminishing substantially towards an opposite circumferential end.

16. A roller bearing cage according to claim 15, wherein the differently-diminishing recesses are disposed in an alternating manner in a longitudinal direction of the at least one bridge element, the longitudinal direction being substantially perpendicular to the circumferential direction.

17. A roller bearing cage according to claim 16, wherein longitudinal extensions of the recesses are oriented at least one of tangentially and obliquely to the circumferential direction.

18. A roller bearing cage according to claim 17, wherein differently-oriented recesses are disposed symmetrically with reference to a middle point of the at least one bridge element.

19. A roller bearing cage according to claim 18, wherein the recesses have a maximum depth greater than about 0.05 mm.

20. A roller bearing cage according to claim 19, wherein a plurality of bridge elements are bonded to at least one annular circumferential element, each bridge element having said recesses.

21. A roller bearing cage according to claim 20, wherein the bridge elements and the at least one annular circumferential element have complementary shapes, such that respective mounted positions of the bridge elements on the annular circumferential element are predetermined in at least one of a circumferential direction and an axial direction of the annular circumferential element.

22. A roller bearing cage according to claim 21, wherein the bridge elements and the at least one annular circumferential element comprise an iron material and the bridge elements are welded to the at least one annular circumferential element.

23. A roller bearing cage according to claim 21, wherein the annular circumferential element is formed from a material having different material properties than the bridge elements.

24. A roller bearing cage according to claim 21, wherein at least one segment of the bridge elements has an at least substantially trapezoid-shaped cross-section.

25. A roller bearing cage according to claim 24, wherein at least one side of the trapezoid-shape is curved to conform to the outer surface of the roller body.

26. A roller bearing cage according to claim 21, wherein the bridge elements are cut to length from one of a profiled bar and a strip material.

27. A roller bearing cage according to claim 21, wherein the roller bearing cage is configured to support at least one of a cylindrical roller bearing, a tapered roller bearing and a spherical roller bearing.

28. A roller bearing cage according to claim 15, wherein the roller body is one of a cylindrical roller bearing, a tapered roller bearing and a spherical roller bearing.

29. A roller bearing cage according to claim 15, wherein at least one segment of the bridge element has an at least substantially trapezoid-shaped cross-section with a curved surface that conforms to the outer surface of the roller body.

30. A roller bearing cage according to claim 15, wherein the recesses have a maximum depth greater than about 0.05 mm.

31. A roller bearing cage according to claim 15, wherein the recesses have a maximum depth greater than about 0.1 mm.

32. A roller bearing cage according to claim 15, wherein longitudinal extensions of the recesses are oriented at least one of tangentially and obliquely to the circumferential direction.

33. A roller bearing cage, comprising:
a first annular element,
a second annular element, and
a plurality of bridge elements connecting the first and second annular elements in an axial direction, each bridge element having first and second support surfaces configured to directly oppose an outer surface of respective roller bodies, each bridge element having a plurality of oblong macroscopic recesses configured to retain lubricant therein, the recesses being formed in each support surface over 50-90% of a circumferential direction of the respective support surface, the circumferential direction being at least substantially perpendicular to the axial direction, each recess having at least one of a width and a depth that diminishes in the circumferential direction, wherein the at least one of the width and the depth of a first group of the recesses diminishes in the circumferential direction substantially towards one circumferential edge of the bridge element and the at least one of the width and the depth of a second group of the recesses diminishes in the circumferential direction substantially towards an opposite circumferential edge of the bridge element.

34. A roller bearing cage according to claim 33, wherein:
the first and second groups of recesses each constitute approximately 50% of a total number of recesses formed in the support surfaces,
both the width and the depth of each recess diminishes in the circumferential direction,
each recess has a maximum depth of at least 0.05 mm,
a longitudinal extension of the first group of recesses is obliquely oriented relative to the circumferential direction by an angle that is equal to an angle that a longitudinal extension of the second group of recesses is obliquely oriented relative to the circumferential direction, but in an opposite direction,
the recesses of the first and second groups are disposed in a substantially alternating manner along the axial direction of each bridge element, and
at least one segment of the bridge element has an at least substantially trapezoid-shaped cross-section with curved surfaces that conform to the outer surfaces of the respective roller bodies.
